(19) United States
(12) Patent Application Publication
(10) Pub. No.: US 2007/0174337 A1
(43) Pub. Date: Jul. 26, 2007

(54) Testing quality of relationship discovery

(76) Inventors: Debra Brouse LaVergne, Palo Alto, CA (US); Lingling Yan, San Jose, CA (US)

Correspondence Address: KONRAD RAYNES & VICTOR, LLP;ATTN: IBM54, 315 SOUTH BEVERLY DRIVE, SUITE 210, BEVERLY HILLS, CA, 90212, US

(21) Appl. No.: 11/339,128

(22) Filed: Jan. 24, 2006

(51) Int. Cl. G06F 17/00

(52) U.S. Cl. 707/104.1

(57) ABSTRACT

Provided are techniques for testing quality of relationship discovery. Reference mappings and test mappings are received, wherein each of the reference mappings and test mappings includes one or more mappings, and wherein each of the mappings includes a mapping input and a mapping output, Each of the reference mappings and test mappings is parsed to generate a reference structure and a test structure, wherein the reference structure and test structure each contains entries with mapping outputs as keys matched with mapping inputs as values. The reference structure and the test structure are compared to determine the quality of relationships discovered in the test mappings.

### BACKGROUND

1. Field

Embodiments of the invention relate to testing the quality of relationship discovery.

2. Description of the Related Art

There are some discovery tools that discover relationships of columns in tables in a first file and columns in tables of a second file. For example, a first column in the first file may be for Zipcode, while a second column in the second file may be for PostalCode. The discovery tool uses several name and data matching techniques to discover that there is a relationship between the Zipcode column in the first file and the PostalCode column in the second file. The discovery tool generates a test mapping file that shows that the PostalCode column maps to the Zipcode column. In particular, the discovery tool may receive the Zipcode column as a mapping input and outputs the PostalCode column as a mapping output to indicate that the PostalCode column is mapped to the Zipcode column.

The test mapping file is generated by the discovery tool. The test mapping file may be described as containing elements referred to as mappings. Each mapping has mapping inputs and mapping outputs. For example, one mapping may define a mapping input of Zipcode and a mapping output of PostalCode. In order to determine whether the discovery tool has discovered desired relationships, the test mapping file is examined. This manual examination is slow, tedious and error-prone.

One improvement is to compare a reference mapping file against the test mapping file. Currently, the reference mapping file is manually created. The reference mapping file also includes mapping elements. In order to determine whether the discovery tool has discovered the desired relationships, the reference mapping file and the test mapping file are manually compared. This manual comparison is slow, tedious and error-prone. Moreover, file comparison between the reference mapping file and the test mapping file requires that entries be in the same order in the two files. Therefore, if the entries are not in the same order, the manual comparison is even more difficult. Thus, testing relationship discovery is difficult.

Thus, there is a need in the art for improved testing of the quality of relationship discovery.

### SUMMARY OF EMBODIMENTS OF THE INVENTION

Provided are a method, computer program product, and system for testing quality of relationship discovery. Reference mappings and test mappings are received, wherein each of the reference mappings and test mappings includes one or more mappings, and wherein each of the mappings includes a mapping input and a mapping output. Each of the reference mappings and test mappings is parsed to generate a reference structure and a test structure, wherein the reference structure and test structure each contains entries with mapping outputs as keys matched with mapping inputs as values. The reference structure and the test structure are compared to determine the quality of relationships discovered in the test mappings.

### BRIEF DESCRIPTION OF THE DRAWINGS

Referring now to the drawings in which like reference numbers represent corresponding parts throughout:

FIG. 1 illustrates details of a computing device in accordance with certain embodiments.

FIG. 2 illustrates logic for processing mangled schemas in accordance with certain embodiments.

FIG. 3 illustrates logic for determining a quality of relationship discovery in accordance with certain embodiments.

FIG. 4 illustrates logic for comparing a reference structure with a test structure in accordance with certain embodiments.

FIG. 5 illustrates a sample report in accordance with certain embodiments.

FIG. 6 illustrates an architecture of a computer system that may be used in accordance with certain embodiments.

### DETAILED DESCRIPTION

In the following description, reference is made to the accompanying drawings which form a part hereof and which illustrate several embodiments of the invention. It is understood that other embodiments may be utilized and structural and operational changes may be made without departing from the scope of the invention.

Embodiments automatically compare each mapping in a test mapping file to each mapping in reference mapping file.

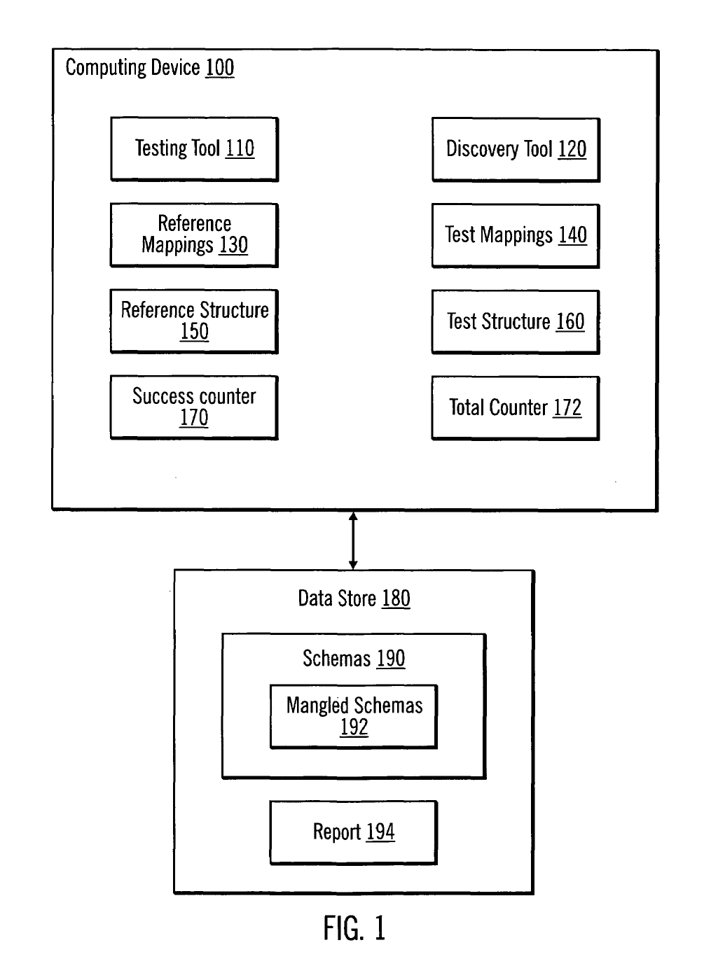

FIG. 1 illustrates details of a computing device 100 in accordance with certain embodiments. The computing device 100 is coupled to a data store 180, which stores one or more schemas 190. Mangled schemas 192 are a type of schema 190. The computing device 100 includes a testing tool 110 and a discovery tool 120. The discovery tool 120 generates test mappings 140 for schemas 190. That is, the discovery tool 120 discovers relationships between schemas 190 and generates the test mappings based on the discovered relationships. The computing device 100 also includes reference mappings 130. The testing tool 110 determines the quality of the relationships discovered by the discovery tool 120 by comparing the reference mappings 130 with the test mappings 140. Each of the reference mappings 130 and test mappings 140 may be described as including one or more mappings, and each mapping describes a mapping input and a mapping output.

The testing tool 110 generates a reference structure 150 based on the reference mappings 130 and a test structure 160 based on the test mappings. In certain embodiments, the reference mappings 130 are reference mapping files, and the test mappings 140 are test mapping files. The computing device 100 also includes a success counter 170 and a total counter 172. The computing device 100 may include other components (not shown). The testing tool 110 also generates a report 194, which may be stored in the data store 180.

The computer device 100 may comprise any computing device known in the art, such as a server, mainframe, workstation, personal computer, hand held computer, laptop telephony device, network appliance, etc.

The data store 180 may comprise an array of storage devices, such as Direct Access Storage Devices (DASDs), Just a Bunch of Disks (JBOD), Redundant Array of Independent Disks (RAID), virtualization device, etc.

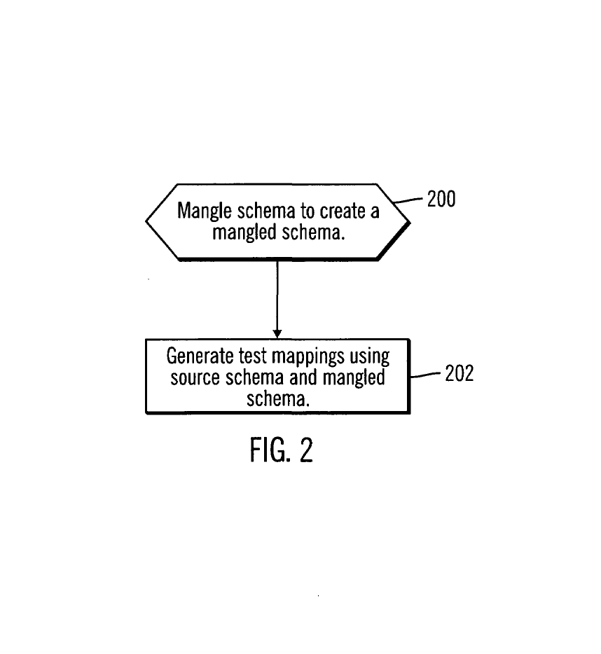

FIG. 2 illustrates logic for processing mangled schemas in accordance with certain embodiments. Control begins at block 200 with testing tool 110 mangling a schema 190 to create a mangled schema 192. Various embodiments implement different mangling techniques to mangle the schema 190 in order to exercise the discovery tool 120 more thoroughly. For example, some mangling techniques change the order of objects in a schema 190 or change the structure of the schema 190 (e.g., by promoting children to siblings in an Extensible Markup Language (XML) Schema Definition (XSD) file). Other mangling techniques mangle names in a schema 190 according to predetermined rules, such as: removing vowels except initial letters, abbreviating names according to a set of keywords, adding a prefix to names, or expanding names.

In block 202, the discovery tool 120 generates test mappings 140 for a source schema and the mangled schema. Mangled schemas may be created in order to create test cases to test for mapping between names in a source schema and names in the mangled schema.

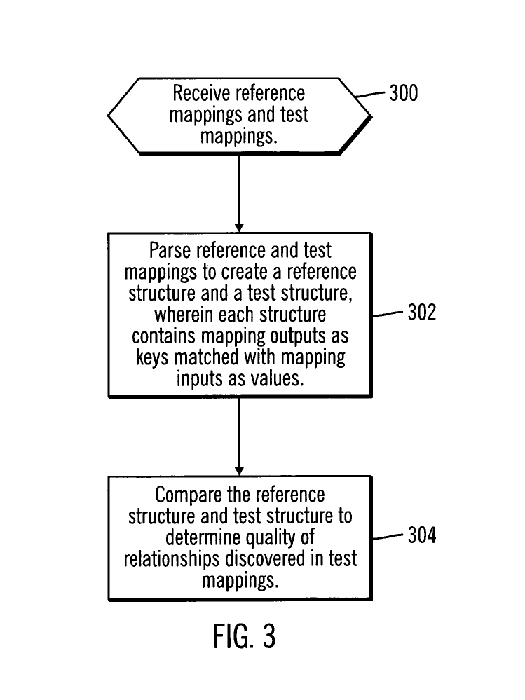

FIG. 3 illustrates logic for determining a quality of relationship discovery in accordance with certain embodiments. Control begins at block 300 with the testing tool 110 receiving reference mappings 130 and test mappings 140. The test mappings 130 may have been generated by the discovery tool 120 using a mangled schema 192. In block 302, the testing tool 110 parses the reference and test mappings 130, 140 to create a reference structure 150 and a test structure 160. The reference and test mappings 130, 140 describe mapping inputs and corresponding mapping outputs. Each structure 140, 150 contains entries with mapping outputs as keys matched with mapping inputs as values.

Structure A illustrates an example structure 150, 160:

Structure A

| | |
|---|---|
| KEY | VALUE |
| (mapping output) | (mapping input) |

In certain embodiments, the reference and test mappings 130, 140 are reference and test files, and the testing tool 110 parses each file to create an instance of a JAVA® HashTable that contains the mapping outputs as keys matched with mapping inputs as values. The outputs are used as keys because there may be multiple inputs for a given output. Optionally, a counter may be added to the keys in the reference and test structures 150, 160 to make keys unique.

In block 304, the testing tool 110 compares the reference structure 150 and the test structure 160 to determine the quality of relationships discovered in the test mappings 160 by the discovery tool 120.

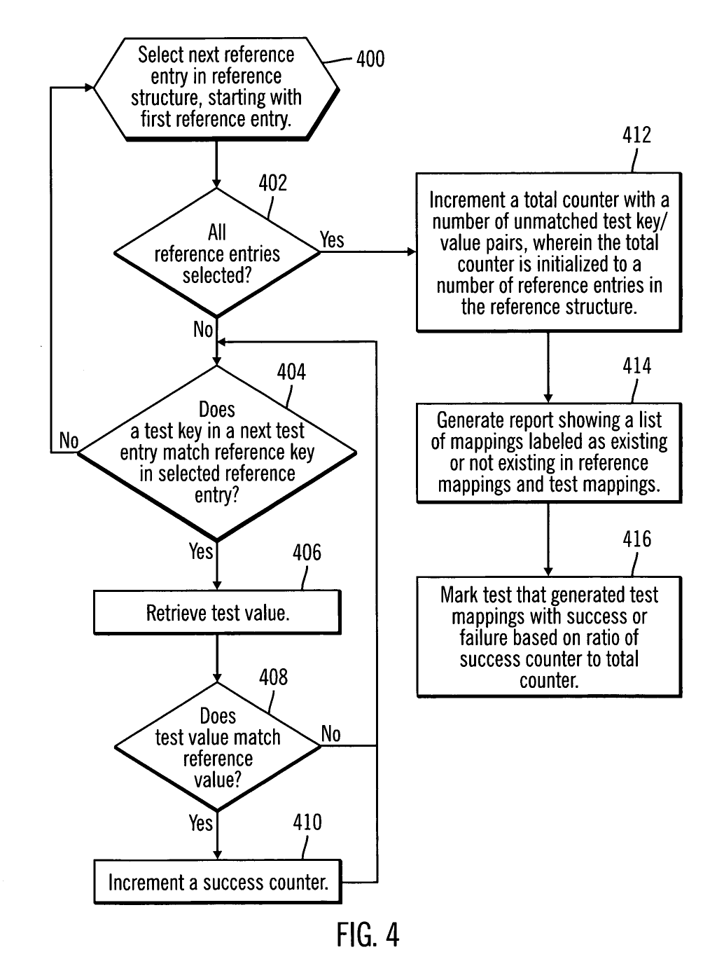

FIG. 4 illustrates logic for comparing a reference structure with a test structure in accordance with certain embodiments. Control begins at block 400 with the testing tool 110 selecting a next reference entry in the reference structure 150, starting with a first reference entry. A reference entry may be described as an entry in the reference structure 150 that includes a key/value pair.

In block 402, the testing tool 110 determines whether all reference entries have been selected. If so, processing continues to block 412, otherwise, processing continues to block 404. In block 404, the testing tool 110 determines whether a test key in a next test entry matches a reference key in the selected reference entry. That is, the testing tool 110 selects a reference entry, retrieves the reference key for that reference entry, and searches the test entries to identify test entries with test keys that match the retrieved reference key. The term “next” is used to indicate that testing tool is searching for another test entry and is not intended to indicate that the order of search is linear. However, in some embodiments, the order of search is linear. If the reference key matches a test key, processing continues to block 406, otherwise, processing loops back to block 400 to select another reference entry.

In block 406, the testing tool 110 retrieves a test value for the test entry whose test key matched the reference key. In block 408, the testing tool determines whether the test value matches the reference value in the selected reference entry. If so, processing continues to block 410, otherwise, processing loops back to block 404 to determine whether another test entry has a test key that matches the reference key of the selected reference entry.

In block 410, the testing tool increments a success counter 170. The success counter 170 keeps a count of verified mappings. From block 410, processing loops back to block 404.

In block 412, the testing tool 110 increments a total counter with a number of unmatched test key/value pairs. The total counter is initialized to a number of reference entries in the reference structure 150 (e.g., if the reference structure 150 has ten entries, then the total counter is initialized to ten).

In block 414, the testing tool 110 generates a report 194 showing a list of mappings (i.e., mapping inputs with corresponding mapping outputs), and each mapping is labeled as existing or not existing in the reference mappings 130 and test mappings 140. A mapping that is labeled as existing is one that is found in the mappings 130, 140. A mapping that is labeled as not existing is one that is not found (i.e., absent) in the mappings 130, 140.

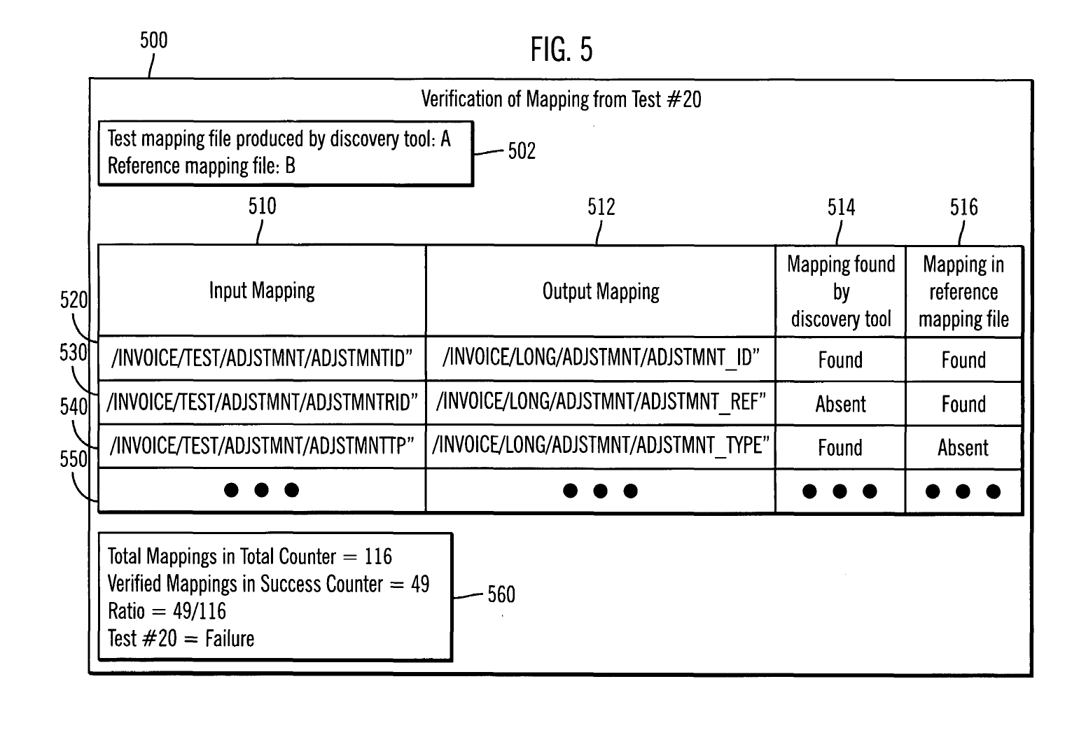

FIG. 5 illustrates a sample report 500 in accordance with certain embodiments. In FIG. 5, the report 500 is titled “Verification of Mapping from Test #20”. Section 502 of the report 500 identifies a test mapping file produced by a discovery tool 120 (“A”) (i.e., an example of test mappings 140) and a reference mapping file (“B”) (i.e., an example of reference mappings 130). The report 500 shows a table with a column for each input mapping 510 and a column for each corresponding output mapping 512, where a mapping is formed by an input mapping and a corresponding output mapping. The table also includes a column 514 that indicates whether a mapping was found by the discovery tool (i.e., whether the mapping is found (“exists”) in the test mapping file) and a column 516 that indicates whether the mapping is found (“exists”) in the reference mapping file.

In this example report 500, for row 520, the input mapping and corresponding output mapping are found in both the test mapping file and the reference mapping file. For row 530, the input mapping and corresponding output mapping are absent (“not existing”) in the test mapping file and are found in the reference mapping file. For row 540, the input mapping and the corresponding output mapping are found in the test mapping file and are absent in the reference mapping file. Row 550 includes ellipses and is intended to represent additional rows of the report that are not shown.

In block 416, the testing tool 110 marks the test performed by the discovery tool 120 that generated the test mappings 140 with success or failure based on a ratio of the success counter 170 to the total counter 172. The marking of success or failure is included in the generated report. For example, with reference to FIG. 5, section 560 indicates that the total mappings in the total counter is 116, while the verified mappings value in the success counter is 49. Therefore, the ratio is 49/166, and the testing tool 110 marks Test #20 with failure. The ratio that represents a successful test may be set in the testing tool 110. For example, for name-matching techniques, a successful test may have a ratio of 0.9. As another example, for data-matching techniques, a successful test may have a ratio of 0.5.

Thus, embodiments enable mangling of schemas to better test the discovery tool 120. Additionally, embodiments assess the accuracy of relationship discovery by comparing the test mappings 140 (i.e., the discovered relationships) against the reference mappings 130.

Certain embodiments are implemented in a testing framework that runs a set of tests defined in a simple text control file.

Thus, embodiments automatically compare each mapping in a test mapping file to each mapping in reference mapping file.

JAVA is a registered trademark or common law mark of Sun Microsystems in the United States and/or other countries.

### Additional Embodiment Details

The described operations may be implemented as a method, computer program product or apparatus using standard programming and/or engineering techniques to produce software, firmware, hardware, or any combination thereof.

Each of the embodiments may take the form of an entirely hardware embodiment, an entirely software embodiment or an embodiment containing both hardware and software elements. The embodiments may be implemented in software, which includes but is not limited to firmware, resident software, microcode, etc.

Furthermore, the embodiments may take the form of a computer program product accessible from a computer-usable or computer-readable medium providing program code for use by or in connection with a computer or any instruction execution system. For the purposes of this description, a computer-usable or computer readable medium may be any apparatus that may contain, store, communicate, propagate, or transport the program for use by or in connection with the instruction execution system, apparatus, or device.

The described operations may be implemented as code maintained in a computer-usable or computer readable medium, where a processor may read and execute the code from the computer readable medium. The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a rigid magnetic disk, an optical disk, magnetic storage medium (e.g., hard disk drives, floppy disks, tape, etc.), volatile and non-volatile memory devices (e.g., a random access memory (RAM), DRAMs, SRAMs, a read-only memory (ROM), PROMs, EEPROMs, Flash Memory, firmware, programmable logic, etc.). Current examples of optical disks include compact disk—read only memory (CD-ROM), compact disk—read/write (CD-R/W) and DVD.

The code implementing the described operations may further be implemented in hardware logic (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a computer readable medium at the receiving and transmitting stations or devices.

A computer program product may comprise computer useable or computer readable media, hardware logic, and/or transmission signals in which code may be implemented. Of course, those skilled in the art will recognize that many modifications may be made to this configuration without departing from the scope of the embodiments, and that the computer program product may comprise any suitable information bearing medium known in the art.

The term logic may include, by way of example, software, hardware, firmware, and/or combinations of software and hardware.

Certain implementations may be directed to a method for deploying computing infrastructure by a person or automated processing integrating computer-readable code into a computing system, wherein the code in combination with the computing system is enabled to perform the operations of the described implementations.

The logic of FIGS. 2, 3, and 4 describes specific operations occurring in a particular order. In alternative embodiments, certain of the logic operations may be performed in a different order, modified or removed. Moreover, operations may be added to the above described logic and still conform to the described embodiments. Further, operations described herein may occur sequentially or certain operations may be processed in parallel, or operations described as performed by a single process may be performed by distributed processes.

The illustrated logic of FIGS. 2, 3, and 4 may be implemented in software, hardware, programmable and non-programmable gate array logic or in some combination of hardware, software, or gate array logic.

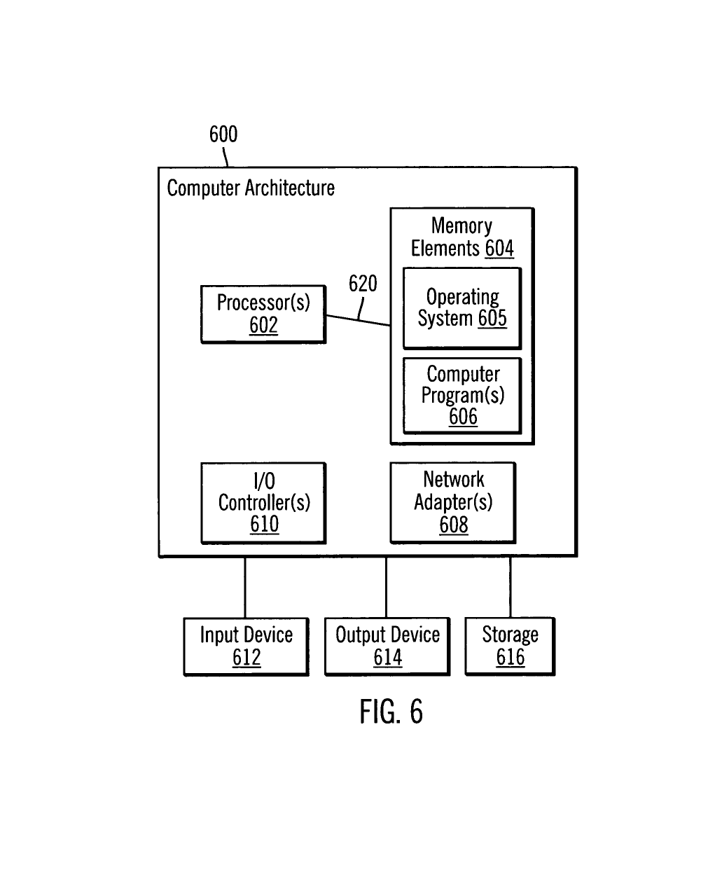

FIG. 6 illustrates a system architecture 600 that may be used in accordance with certain embodiments. Computing device 100 may implement system architecture 600. The system architecture 600 is suitable for storing and/or executing program code and includes at least one processor 602 coupled directly or indirectly to memory elements 604 through a system bus 620. The memory elements 604 may include local memory employed during actual execution of the program code, bulk storage, and cache memories which provide temporary storage of at least some program code in order to reduce the number of times code must be retrieved from bulk storage during execution. The memory elements 604 include an operating system 605 and one or more computer programs 606.

Input/Output (I/O) devices 612, 614 (including but not limited to keyboards, displays, pointing devices, etc.) may be coupled to the system either directly or through intervening I/O controllers 610.

Network adapters 608 may also be coupled to the system to enable the data processing system to become coupled to other data processing systems or remote printers or storage devices through intervening private or public networks. Modems, cable modem and Ethernet cards are just a few of the currently available types of network adapters 608.

The system architecture 600 may be coupled to storage 616 (e.g., a non-volatile storage area, such as magnetic disk drives, optical disk drives, a tape drive, etc.). The storage 616 may comprise an internal storage device or an attached or network accessible storage. Computer programs 606 in storage 616 may be loaded into the memory elements 604 and executed by a processor 602 in a manner known in the art.

The system architecture 600 may include fewer components than illustrated, additional components not illustrated herein, or some combination of the components illustrated and additional components. The system architecture 600 may comprise any computing device known in the art, such as a mainframe, server, personal computer, workstation, laptop, handheld computer, telephony device, network appliance, virtualization device, storage controller, etc.

The foregoing description of embodiments of the invention has been presented for the purposes of illustration and description. It is not intended to be exhaustive or to limit the embodiments to the precise form disclosed. Many modifications and variations are possible in light of the above teaching. It is intended that the scope of the embodiments be limited not by this detailed description, but rather by the claims appended hereto. The above specification, examples and data provide a complete description of the manufacture and use of the composition of the embodiments. Since many embodiments may be made without departing from the spirit and scope of the embodiments, the embodiments reside in the claims hereinafter appended or any subsequently-filed claims, and their equivalents.

What is claimed is:

1. A computer-implemented method for testing quality of relationship discovery, comprising:
receiving reference mappings and test mappings, wherein each of the reference mappings and test mappings includes one or more mappings, and wherein each of the mappings includes a mapping input and a mapping output;
parsing each of the reference mappings and test mappings to generate a reference structure and a test structure, wherein the reference structure and test structure each contains entries with mapping outputs as keys matched with mapping inputs as values; and
comparing the reference structure and the test structure to determine the quality of relationships discovered in the test mappings.

2. The method of claim 1, further comprising:
selecting a reference entry in the reference structure having a reference key; and
searching for a test entry in the test structure having a test key that matches the reference key.

3. The method of claim 2, further comprising:
in response to locating the test entry with the test key that matches the reference key, comparing a test value in the test entry with a reference value in the reference entry; and
in response to determining that the test value and reference value match, incrementing a success counter.

4. The method of claim 3, further comprising:
in response to determining that the test value and reference value do not match, incrementing a total counter, wherein the total counter is initialized to a number of reference entries in the reference structure.

5. The method of claim 4, further comprising:
marking a test that generated the test mappings with success or failure based on a ratio of the success counter to the total counter.

6. The method of claim 1, further comprising:
generating a report showing a list of mappings, wherein each of the mappings is labeled as existing or not existing in the reference mappings and test mappings.

7. The method of claim 1, further comprising:
mangling a schema to create a mangled schema.

8. A computer program product for testing quality of relationship discovery comprising a computer useable medium including a computer readable program, wherein the computer readable program when executed on a computer causes the computer to:
receive reference mappings and test mappings, wherein each of the reference mappings and test mappings includes one or more mappings, and wherein each of the mappings includes a mapping input and a mapping output;
parse each of the reference mappings and test mappings to generate a reference structure and a test structure, wherein the reference structure and test structure each contains entries with mapping outputs as keys matched with mapping inputs as values; and
compare the reference structure and the test structure to determine the quality of relationships discovered in the test mappings.

9. The computer program product of claim 8, wherein the computer readable program when executed on a computer causes the computer to:
select a reference entry in the reference structure having a reference key; and
search for a test entry in the test structure having a test key that matches the reference key.

10. The computer program product of claim 9, wherein the computer readable program when executed on a computer causes the computer to:
in response to locating the test entry with the test key that matches the reference key, compare a test value in the test entry with a reference value in the reference entry; and
in response to determining that the test value and reference value match, increment a success counter.

11. The computer program product of claim 10, wherein the computer readable program when executed on a computer causes the computer to:
in response to determining that the test value and reference value do not match, increment a total counter, wherein the total counter is initialized to a number of reference entries in the reference structure.

12. The computer program product of claim 11, wherein the computer readable program when executed on a computer causes the computer to:
mark a test that generated the test mappings with success or failure based on a ratio of the success counter to the total counter.

13. The computer program product of claim. 8, wherein the computer readable program when executed on a computer causes the computer to:
generate a report showing a list of mappings, wherein each of the mappings is labeled as existing or not existing in the reference mappings and test mappings.

14. The computer program product of claim 8, wherein the computer readable program when executed on a computer causes the computer to:
mangle a schema to create a mangled schema.

15. A system for testing quality of relationship discovery, comprising:
logic capable of performing operations, the operations comprising:
receiving reference mappings and test mappings, wherein each of the reference mappings and test mappings includes one or more mappings, and wherein each of the mappings includes a mapping input and a mapping output;
parsing each of the reference mappings and test mappings to generate a reference structure and a test structure, wherein the reference structure and test structure each contains entries with mapping outputs as keys matched with mapping inputs as values; and
comparing the reference structure and the test structure to determine the quality of relationships discovered in the test mappings.

16. The system of claim 15, wherein the operations further comprise:
selecting a reference entry in the reference structure having a reference key; and
searching for a test entry in the test structure having a test key that matches the reference key.

17. The system of claim 16, wherein the operations further comprise:
in response to locating the test entry with the test key that matches the reference key, comparing a test value in the test entry with a reference value in the reference entry; and
in response to determining that the test value and reference value match, incrementing a success counter.

18. The system of claim 17, wherein the operations further comprise:
in response to determining that the test value and reference value do not match, incrementing a total counter, wherein the total counter is initialized to a number of reference entries in the reference structure.

19. The system of claim 18, wherein the operations further comprise:
marking a test that generated the test mappings with success or failure based on a ratio of the success counter to the total counter.

20. The system of claim 15, wherein the operations further comprise:
generating a report showing a list of mappings, wherein each of the mappings is labeled as existing or not existing in the reference mappings and test mappings.

21. The system of claim 15, wherein the operations further comprise:
mangling a schema to create a mangled schema.
